(19) United States
(12) Patent Application Publication
(10) Pub. No.: US 2019/0282891 A1
(43) Pub. Date: Sep. 19, 2019

(54) APPARATUS AND METHOD OF COMMUNICATING THE PRESENCE OF AN OBJECT TO A COMPUTER

(71) Applicant: KONINKLIJKE PHILIPS N.V., EINDHOVEN (NL)

(72) Inventors: VINCENTIUS PAULUS BUIL, VELDHOVEN (NL); LUCAS JACOBUS FRANCISCUS GEURTS, BEST (NL)

(21) Appl. No.: 16/301,189

(22) PCT Filed: May 24, 2017
(86) PCT No.: PCT/EP2017/062560

§ 371 Date: Nov. 13, 2018

(30) Foreign Application Priority Data
May 25, 2016 (EP) 16171213.8

(51) Int. Cl. A63F 13/212; A63F 13/235; A63F 13/323

(52) U.S. Cl. CPC A63F 13/212; A63F 13/323; A63F 13/235

(57) ABSTRACT

There is provided an activity controller and activity accessory. These both comprise a body-coupled communication device configured to communicate, using body-coupled communications, with each other when both are touched by a activity performer and to obtain a activity accessory information and a positional information indicative of the position of the activity accessory device relative to the activity controller. The activity controller comprises a processor configured to formulate activity commands for an activity console based on said activity accessory information and on said positional information, and a linking device configured to communicate said activity commands to the activity console. Uses for gaming, computer assisted therapy and positioning of sensors or defibrillator electrodes are provided.

### FIELD

The present invention concerns the interaction of persons with computer programs where the person wishes to indicate to the program that they have a certain object. Of particular relevance are computer games.

### BACKGROUND

There are many situations where it could be useful for a person using a computer running a computer program to signal to the computer program that they are in possession of a particular object.

A notable case is computer games. These are very widely used and may be run on general purpose computers or games consoles which are computers specially configured for running computer games. Usually the player sends commands to the game by the use of an interface device which then communicates those commands to the computer or console. In the case of consoles this interface device is often called a game controller which the player often holds in their hands.

In many games the player controls a character who is represented visually on the screen. Part of the game-play is to obtain objects which the character then uses in game such as swords or staffs giving magic powers or games. Another example involves working in the game to ‘unlock’ characters so that they can be used in the game.

In many cases the player can actually purchase physical items, usually resembling the object or character in the game. To achieve the activation of the object or character in the game the player must identify themselves and that they have the object, which is tedious but necessary since many games involve many people playing together simultaneously. In one case the objects are characters that are placed in a special cradle that is attached to the computer or game console which saves identifying the object but still leaves the identification of the player so that the activation in the game is associated with the right player. It also still requires the cradle which limits play to a home setting or means carrying the cradle around.

There are other games where the players movements, or rather the movements they make with the controller (which contains inertial sensors), are reproduced by a character in the game such as dancing to music played by the game or moving an object around like in tennis or actually ‘shooting’ a model of a gun at the screen. In those cases, the controller is inserted into the tennis racket or gun. This has the disadvantage that the object must have a recess to receive the controller which adds cost and requires that the form of the object be less realistic and comfortable for the player. Also repeated insertions often break either the object or the controller.

Wireless connections between the controller and the object could be possible, however this would only allow registering the presence of the object—its position on the player would remain unknown. For a game where the object is held continuously during the game and where it is displayed in the hands of a game character, it would be for the game to know in which hand the object is held—which is not possible with a wireless link. Also there is the risk of false registrations because the object may in fact be on someone else nearby.

### SUMMARY

Therefore it is desirable to provide an activity controller comprising: A body-coupled communication device configured to communicate, using body-coupled communications, the body coupled communications having an associated field, with an activity accessory device when both the body-coupled communication device and the activity accessory device are touched by an activity performer and to obtain, via the body-coupled communications, a activity accessory information and a positional information indicative of the position in terms of the activity performer's body, of the activity accessory device relative to the activity controller, wherein the game accessory information comprises an identifier of an activity object and the positional information is at least in part based a measured value representing the strength of the associated field, a processor configured to formulate activity commands for an activity console based on said activity accessory information and on said positional information, and a linking device configured to communicate said activity commands to the activity console.

This may be used by players of on-line games who sometime suffer hacking of their game accounts and the theft of the character that they have built in the game program or of game objects that the character possesses. The fact that possession of an object outside the game, namely a game accessory, is required to allow playing of that game object adds a level of security. This applies equally to the game character when the game accessory identifies the character. It will be understood that this is a significant advantage when it is realised that players invest considerable time and money building their character and the game objects it possesses.

The embodiment could also be used in a medical setting. Increasingly, computers are used to assist practitioners while they perform procedures on a patient. An example of this is seen in surgery where the surgeon uses computer-aided imaging for guidance. Here the ‘game controller’ would be a device for connecting the surgeon to the guidance device, the ‘game program’ would be the guidance program and the ‘game accessory’ would be a surgical implement that the guidance program is to recognize. This has the advantage that the guidance program can recognize the implement simply by having the surgeon touch it without having to delay or complicate the procedure.

According to an embodiment, the activity controller is configured to detect whether the body-coupled identifier device is in direct contact or indirect contact with the activity performer. The distinction between direct and indirect contact can be used advantageously by the game to determine the value of a quality relative to the game object 8. For example, this could be a level of strength or power, such as armor with more strength or a sword having more force.

According to an embodiment, the activity controller of claim 1 wherein the positional information is further indicative a distance over the body surface of the activity performer between activity controller and the activity accessory. The distance between the activity controller and the activity accessory could be used be the game program to adjust the display to reflect the situation of the player. Advantageously this could be done automatically during the game without interruption and so giving a better game experience.

According to an embodiment, the activity controller has positional information indicative of whether the activity controller and the activity accessory device are on the same limb or different limbs. In this case, the game will be able to adjust automatically to which hand the accessory is held and indeed be able to do this during the game and without interruption. This is a significant advantage over the situation where either the hand must be used or where the game must be stopped temporarily to change hands.

According to an embodiment, activity controller has the positional information is indicative of the area of skin contact between the activity performer and the activity accessory. This gives the advantage that the game can distinguish between one and two-handed use automatically during the running of the game.

According to an embodiment, the activity controller has the positional information communicated in the activity command as value representative of a field strength of the communication between the activity controller and the activity accessory device. The game accessories may be grouped into categories such as a character or weapon (like a gun or a sword) or some other object to be used by the character such as clothing or medicine. The game can then interpret the positional information differently according to the category. For example, for a character the positional information could be ignored whereas for objects it could be used. For medicine or food, the positional information could be interpreted as ‘near’ and meaning in the character's hand and ‘far’ meaning in a pocket or pouch. For an object like a sword, the positional information could be split into ‘very near’ meaning on the same limb as the controller, ‘near’ meaning on another limb but in direct contact and ‘far’ meaning in a holder. The same embodiment may be used in an analogous fashion in a medical environment.

Thus the executing of a game action can be based on the positional information taken in conjunction with properties of a game object associated with the game accessory device. This has an advantage in that the positional information can be simply representative of a signal level of the communication between the game controller and the game accessory device, thereby allowing the processor in the game controller to be relatively simple.

In another aspect there is provided an activity accessory device comprising a body-coupled communication device and configured to communicate with an activity controller as outlined above. When used with an activity controller according to an embodiment, the advantages described above may be obtained.

According to an embodiment, the activity accessory device is configured to store at least one of an activity performer's identity, the activities in which the activity accessory has been used, the performance in the activity of the activity performer and information to be used by the activity to implement the activity object. This has the advantages of adding security and allowing that data to be used in the game when run on another console. It also has the advantages of allowing implementation of the game object in the game without the game program having to be provided with the information beforehand.

According to an embodiment, the activity accessory device is arranged to detect if it is in a holder as a status and communicate said status to an activity controller. When the player removes the activity accessory from the holder, the game can register this automatically and adjust accordingly without interruption to the game. Being in the holder or not could also be used to enable or disable the activity object. For example the holder could have shielding such that the body-coupled communication link is broken when the game or activity accessory is in the holder.

According to an embodiment, the activity accessory has the body-coupled communication device having two sets of coupling plates arranged to detect whether one or two hands are in contact with the activity accessory. This gives the advantage that the game can distinguish between one and two-handed use automatically during the running of the game.

In another aspect there is provided a computer software product stored on a computer readable medium, when run on a activity console having a activity object module configured to perform a activity action according to information concerning a activity accessory received from a activity controller, said activity accessory information and being obtained by the activity controller using body-coupled communications with a activity accessory device.

According to an embodiment, the computer software product has the activity object module configured to produce a said activity object, the activity object being sensorially detectable by an activity performer. This has the advantage that a living being may use the game or activity program as input.

According to an embodiment, the computer software product has the activity object configured module to receive and process information to produce the activity object, the information being stored in the activity accessory device and received via the activity controller. This allows for simplification of the game or activity program.

According to an embodiment, the computer program product is further configured to perform activity actions based on positional information received from the activity controller, said positional information being representative of a distance over the surface of an activity performer's body between the activity controller and the activity accessory.

According to an embodiment, the computer software product has the executing of an activity action further based on the positional information taken in conjunction with properties of an activity object associated with the activity accessory device. This has an advantage in that the positional information can be simply representative of a signal level of the communication between the activity controller and the game accessory device, thereby allowing the processor in the activity controller to be relatively simple.

In another aspect, there is provided a method of executing a activity action within a computer program product when run on a activity console comprising performing a measurement of a strength of a field associated with a body-coupled communication link to obtain a value, receiving an information via said activity controller, the information being obtained by the activity controller using a body-coupled communication link with a activity accessory device when a activity performer's body is in contact with both the activity controller and the activity accessory device, wherein at least part of the information identifies the activity accessory device and at least part of the information provides an indication of a position, the indication being based on the value, of the activity accessory device, in terms of the activity performer's body, relative to the activity controller; and decoding said information and selecting a activity action in accordance with said information.

According to an embodiment, the method has the activity action comprising producing sensorially detectable representation of an activity object.

According to an embodiment, the method has the information to produce the representation stored in the activity accessory device and received via the activity controller

According to an embodiment, the method is further configured to perform a activity action based on positional information received from the activity controller, said positional information being representative of a distance over the surface of a activity performer's body between the activity controller and the activity accessory.

### BRIEF DESCRIPTION OF THE FIGURES

The above, as well as additional objects, features and advantages of the disclosed lighting devices, lighting systems and methods, will be better understood through the following illustrative and non-limiting detailed description of embodiments of devices and methods, with reference to the appended drawings, in which:

FIG. 1 represents a player playing a computer game in which an accessory is used according to an embodiment.

FIG. 2 represents a game controller according to an embodiment.

FIG. 3 represents a game accessory according to an embodiment.

FIG. 4 represents a player playing a computer game in which an accessory is used according to an embodiment in a configuration different to FIG. 1.

FIG. 5 represents a player playing a computer game in which an accessory is used according to an embodiment in a configuration different to FIGS. 1 and 4.

FIG. 6 represents a game program according to an embodiment.

FIG. 7 represents a flow of a computer game program according to an embodiment.

FIG. 8 represents two players playing a computer game in which an accessory is used according to an embodiment.

### DETAILED DESCRIPTION

In the following description, same references designate like elements. Where an element has been described once, further description will not be given, unless necessary.

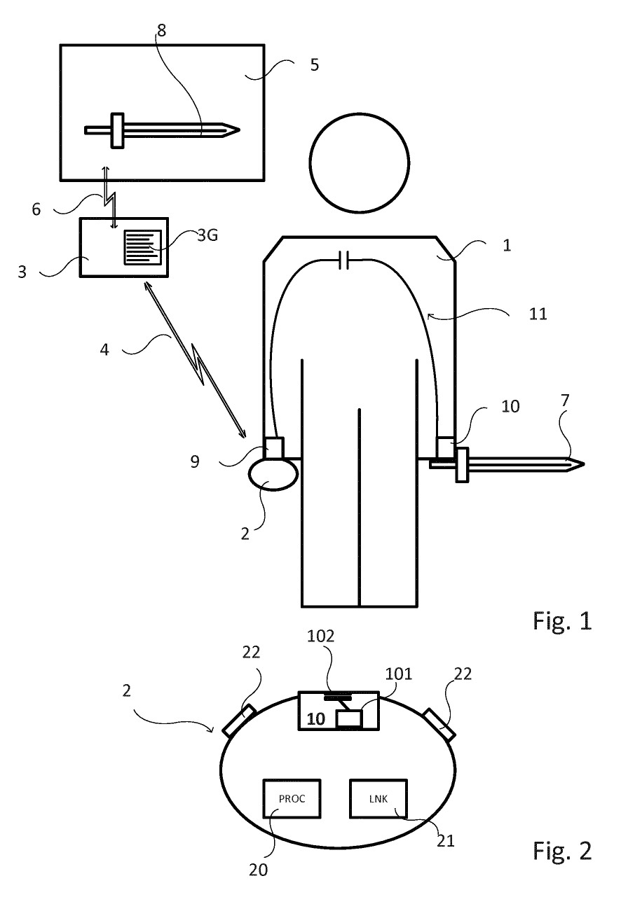

FIG. 1 represents the performing of an activity such as the playing of a computer game 3G. A player 1 holds a game or activity controller 2 which communicates with a computer or game or activity console 3, on which the game or 3G is running, via a first communication link 4. The game or activity console 3 communicates with a display device 5, such as a television or computer monitor, via a second communication link 6. The first and second communication links 4, 6 may be wireless or using cables. The player 1 also holds a physical item or game or activity accessory 7 which may be a solid representation of a game or activity object 8. The game controller 2 has a body-coupled communication device 9 and the game accessory 7 has a body-coupled communication device 10.

By use of the body-coupled communication devices 9 and 10, the game controller 2 and the game accessory 7 are able to establish a body-coupled communication link 11 when the player 1 touches both. ‘Touch’ here means either direct contact to the skin or indirect contact such as via the player's clothing. Using the body-coupled communication link 11, the game accessory 7 is able to identify itself to the controller 2 and so indicate that the player 1 is in possession of the game accessory 7. The controller communicates this possession to the game console 3 so that this fact is registered in the game 3G. The program of the game 3G may then perform game actions according to information concerning the game accessory 7 it received from the game controller 2. The possession of the game accessory 7 allows the player to use the game object 8 in the game which results in the game displaying the game object 8 on the display 5 in a way which is sensorially detectable i.e. detected by one of a living beings senses (in this case sight) by the player 1. This has the advantage that a living being may use the game or activity program as input.

The body-coupled communication link 11 has the advantage that the presence of the game accessory 7 is only registered when the player 1 comes into contact with the game accessory 7. If a wireless link were to be used, its range would require careful tuning to as to allow a distance between game accessory 7 and game controller 2 which is comfortable for the player 1 yet avoids registering game accessories which are in the general vicinity but which should not be registered. Such as system would require an extra level of security by the use of game menus which is undesirable.

FIG. 2 represents a simplified game or activity controller 2. The game controller 2 has a body-coupled communication device 11. The game controller 2 has a processor (PROC) 20 configured to formulate game commands for the game console based on said game-identifier information and a linking device (LNK) 21 configured to communicate said game commands to the game console 3. The game controller 2 has inputs 22 for the player to input commands via the game controller 2. There may be many inputs 22 and some of these may take forms such as buttons, dials, joysticks, touchpads, motion sensors, and so forth. The body-coupled communication device has a transceiver 101 connected to coupling plates 102.

The body-coupled communication link 11 may take the form of an electrostatic field established over the surface of the player's or activity performer's 1 body. The field may be established using capacitive coupling plates as the coupling plates 102 and these are arranged to be in proximity to the player's 1 body. A signal generated by the transceiver 101 is applied to the coupling plates 102 in order to modulate the electrostatic field of the body-coupled communication link 11 and so transmit information. Inductive coupling may also be used in which case the nature of the field will be different.

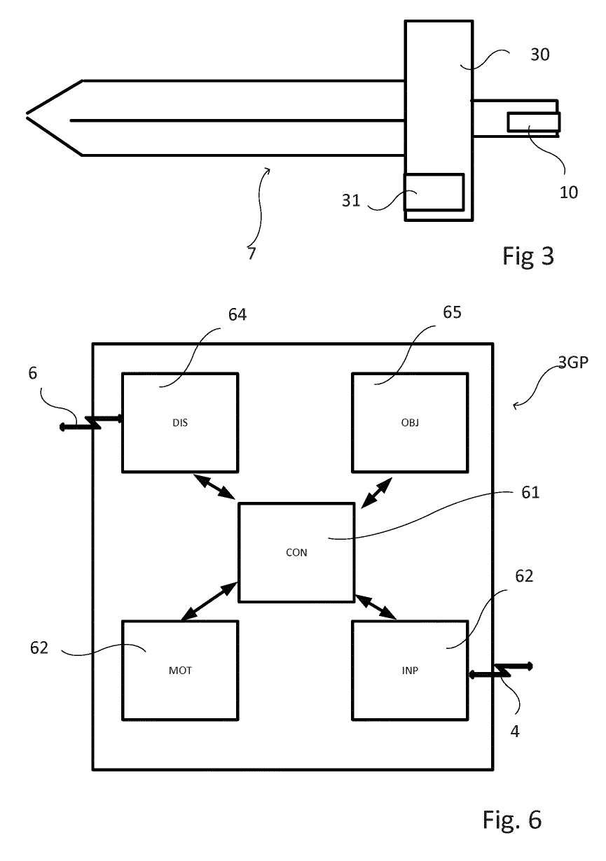

FIG. 3 represents a simplified game or activity accessory 7. The game accessory 7 has a housing 30 which may be in a form resembling the game object 8 it is intended to allow the player 1 to use in the game 3G. In the housing 30 is mounted the body-coupled communication device 10 and a logic circuit 31 able to store information concerning the game object 8 such as an identifier that the game program uses to select the game object 8. The body-coupled communication device 10 has a similar structure to that of the body-coupled communication device 9. In virtual reality systems, the game accessory 7 could be a small module containing the body-coupled communication device 10 and the logic circuit 31, the whole being designed to be held in contact with the player. Tactile stimulation could be used to give the player 1 the impression of holding the game object 8.

The body-coupled communication device 9 of the game controller 2 is configured to communicate, using body-coupled communications, with the body-coupled communication device 10 of game accessory device 7 when both the body-coupled communication device and the game-identifier device are touched by a player 1. Thus this system has the advantage that the player is able to signal possession of the game accessory 7 to the game 3G, without having to resort to stopping the game 3G and entering a menu system or using a special cradle which would otherwise have to be carried around.

Players of on-line games sometime suffer hacking of the game accounts and the theft of the character that they have built in the game program or of game objects that the character possesses. The fact that possession of an object outside the game 3G, namely a game accessory 7, is required to allow playing of that game object 8 adds a level of security. This applies equally to the game character when the game accessory 7 identifies the character. It will be understood that this is a significant advantage when it is realised that players invest considerable time and money building their character and the game objects it possesses.

The embodiment could also be used in a medical setting. Increasingly, computers are used to assist practitioners while they perform procedures on a patient. An example of this is seen in surgery where the surgeon uses computer-aided imaging for guidance. Here the ‘game controller’ would be a device for connecting the surgeon to the guidance device, the ‘game program’ would be the guidance program and the ‘game accessory’ would be a surgical implement that the guidance program is to recognize. This has the advantage that the guidance program can recognize the implement simply by having the surgeon touch it without having to delay or complicate the procedure.

The shorter the distance between the two body-coupled communication devices 9, 10, the stronger is the electrostatic field. Also when the coupling plates 102 are in direct contact with the player 1 i.e. touching the player's 1 skin, the electrostatic field is stronger than when either or both of the coupling plates 102 are in indirect contact, for example via clothing. The body-coupled communication device 9 of the game controller 2 is further configured to measure the electrostatic field and so is configured to obtain a positional information indicative of the position of the game accessory 7 relative to the game controller 3.

The distance between the game controller 2 and the game accessory 7 could be used be the game program 3G to adjust the display to reflect the situation of the player. Advantageously this could be done automatically during the game without interruption and so giving a better game experience. The distinction between direct and indirect contact can be used advantageously by the game to determine the value of a quality relative to the game object 8. For example, this could be a level of strength or power, such as armor with more strength or a sword having more force.

The measuring of distance could also be used in a setting where a central hub is collecting information from sensors placed on a person's body. Here the relative position could be used to confirm a correct positioning of one or more sensors to a practitioner. It could also be used as an indication of a sufficient distance between defibrillator electrodes where both electrodes are provided with detachable body-coupled communication devices which the defibrillator could use to measure the distance between them. The body-coupled communication devices being detachable is desirable in order to protect them from damage when the shock is applied. It would be also desirable that the defibrillator be automated enough to test the electrode placement and then instruct the removal of the body-coupled communication devices just before it applies or recommends the shocks.

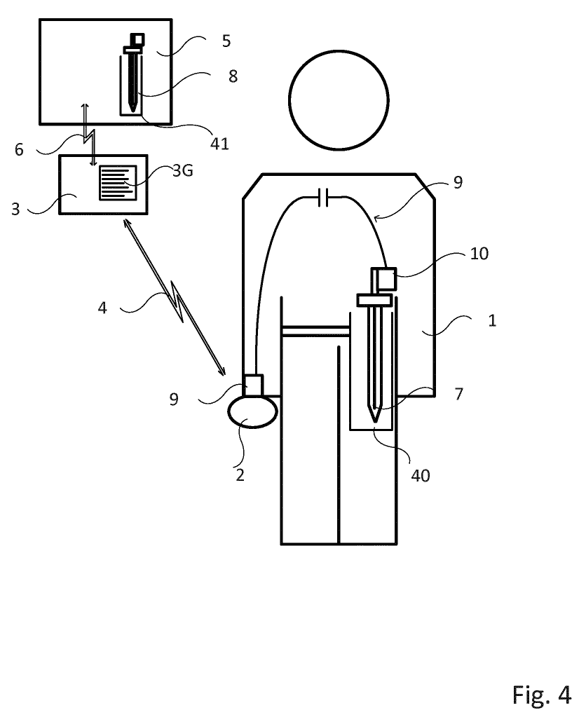

FIG. 4 represents a variation of the situation with reference to FIG. 1. In contrast with FIG. 1, the game accessory 7 is held in a holder 40 which is itself in contact, direct or indirect, with the body of the player 1. The body-coupled device 9 of the game controller 2 measures the strength of the electrostatic field and determines that it is weaker than in the case of FIG. 1. This permits the position of the game accessory 7 to be ascertained. The game 3G accordingly treats the game object 8 as being in a holder and represents it as such in a holder 41 on the display 5.

When the player 1 removes the game accessory 7 from the holder 40, the game 3G can register this automatically and adjust accordingly without interruption to the game. Being in the holder or not could also be used to enable or disable the game object 8. For example the holder could have shielding such that the body-coupled communication link is broken when the game accessory 7 is in the holder 40.

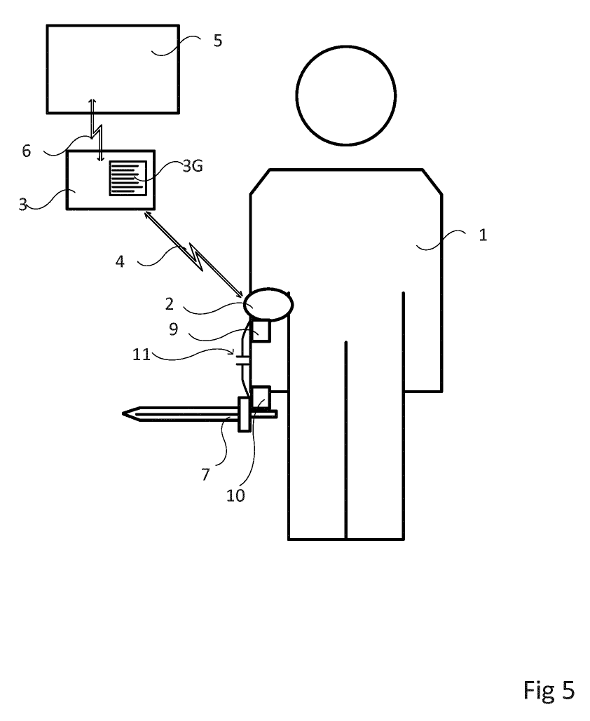

FIG. 5 represents another variation of the situation depicted with reference to FIG. 1. In contrast with FIG. 1, the game controller 2 is attached to the player's 1 arm and the game accessory 7 is held in the hand of that arm. The electrostatic field is stronger than in the previous two cases. Thus the positional information is further indicative a distance over the body surface between the body-coupled communication device and the body-coupled identifier device and whether the game controller 2 and the game accessory device 7 are on the same limb or different limbs of the player.

It is possible for the player 1 to input to the game 3G, either at the time of playing or, more conveniently by settings associated with the character the player 1 is playing, to input to the game 3G which limb the game controller 2 is attached. In this case, the game 3G will be able to adjust automatically to which hand the accessory is held and indeed be able to do this during the game and without interruption. This is a significant advantage over the situation where either the hand must be used or where the game must be stopped temporarily to change hands.

In some games, the game accessory 7 may be held in one hand or two hands. The coupling plates 102 may be arranged where the game accessory is held. Two sets of coupling plates 7 may be arranged so that one set is placed to be in contact with one hand and the other set in contact with the other hand. Alternatively a single set of plates but arranged to cover the area of the game accessory that contacts both hands of the player may be used. The larger area of contact results in a stronger electrostatic field so the positional information is indicative of the area of skin contact between the game-player and the game accessory. This gives the advantage that the game 3G can distinguish between one and two-handed use automatically during the running of the game 3G.

Thus the program of the game 3G is able to perform game actions based on positional information which is representative of a distance over the surface of a game-players body between the game controller and the game accessory 7, offering the advantage that the game 3G can be played without the need for intervention by the player 1.

In a medical setting, with this embodiment, the guidance program could ‘know’ in which hand the practitioner is holding an implement and adjust the display and other settings accordingly. This would offer the advantage of improving the guidance given to the practitioner with reduced intervention in the set-up of the guidance program. Thus the term ‘game’ may be taken as including activities where commands, in particular movements, from a person are interpreted by a computer program so as to perform changes in a displayed representation of an environment.

Another possible use could be in coaching using visual assistance for an activity like a sport. It would be advantageous for the visual assistance program to adapt the assistance being given according to where a piece of sports equipment was contacting the body of the person performing the activity.

The information the game accessory 7 communicates to the game 3G may be a simple identifier which the game uses to select and implement the game object 8 from information held within the game 3G itself. Alternatively the logic circuit 101 of the game accessory may hold the information necessary for the game 3G to implement the game object 8. This has the advantage of making the game 3G easier to expand in that characters and objects may be added to the game without requiring the issuing of expansion versions of the game.

Furthermore the logic circuit 101 may hold a non-volatile storage in which can be written, at suitable moments, information such as the player's 1 identity, which games the accessory has been used and the player's 1 performance (for example the scores). This has the advantage of adding further security and allowing that data to be used in the game when run on another console.

The game accessory 7 may also be provided with means for detecting whether or not it is in the holder 40. For example, electrical contacts could be arranged on the surface of the game accessory 7 so as to contact a conductive strip on the holder 40. The game accessory 7 would then register the short circuit and so detect that it is in the holder and communicate the situation as a status to the game controller 2. This has the advantage of adding an extra confirmation to the positional information.

The game accessory 7 may be grouped into categories such as a character or weapon (like a gun or a sword) or some other object to be used by the character such as clothing or medicine. The game 3G can then interpret the positional information differently according to the category. For example, for a character the positional information could be ignored whereas for objects it could be used. For medicine or food, the positional information could be interpreted as ‘near’ and meaning in the character's hand and ‘far’ meaning in a pocket or pouch. For an object like a sword, the positional information could be split into ‘very near’ meaning on the same limb as the controller, ‘near’ meaning on another limb but in direct contact and ‘far’ meaning in a holder. The same embodiment may be used in an analogous fashion in a medical environment.

Thus the executing of a game action can be based on the positional information taken in conjunction with properties of a game object associated with the game accessory device. This has an advantage in that the positional information can be simply representative of a signal level of the communication between the game controller and the game accessory device, thereby allowing the processor 20 in the game controller to be relatively simple.

The game controller 2 may communicate the positional info to the game 3G as a value indicating the electrostatic field strength, in which case the game 3G interprets the positional information. Alternatively, the game controller 2 may interpret itself the field strength in conjunction with information held concerning the nature of the game accessory 7 in order to provide positional information which indicates the status of the game accessory 7 to the game 3G. This has the advantage that the game 3G does not require knowledge of the game accessories and so updates with new game accessories 7 are easier.

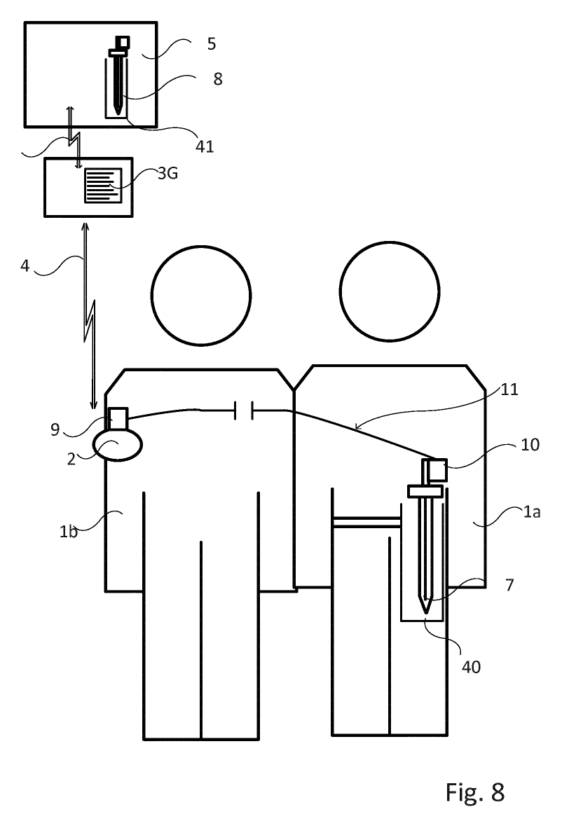

FIG. 8 represents a situation where two players are playing a game together. A first player 1a has or is in contact with the game accessory 7. The game accessory 7 is according to an embodiment as described previously. A second player 1b is contact, direct or indirect with the first player 1a and has a game controller 2 which is according to an embodiment as described previously. The contact between the players 1a, 1b permits the electrostatic field to be established so as to encompass the two players and allow the body-coupled communication link 11 to be created between the game accessory 7 on the first player 1a and the game controller 2 on the second player 1b. In one case the game 3G could simply register that the second player 1b has the game accessory 7. In another case, where the first player 1a also has a game controller (not shown) and is participating in the game 3G at that time, since the game knows that the game controller is on the second player 1b and from previous events that the first player 1a has the game accessory, the game can perform game actions related to transferring the game accessory in the game from the first player 1a to the second player 1b.

The advantage of using a body-coupled communication link is that there is no need to enter game menus for the game to register that the second player 1b now has the game accessory 7. Indeed, in the case where both players 1a, 1b are actively playing, they can pass the game accessory 7 back and forth and have the game 3G register the fact. This can be achieved by having the both game controllers being equipped with body-coupled communication devices 9 communicate between themselves to register the contacting of the players 1a, 1b, successive contacts being interpreted by the game 3G as passing the game accessory 7 from one player to the other. Another advantage can be obtained where both players have the game accessory 7 and where the game accessory represents an ability in the game 3G—in this case, the game 3G can be configured to interpret this as equivalent to adding the abilities together to give one or both of the players in the game more of that ability. This can be advantageously extended to having the game 3G interpret the presence of two different game accessories 7 as meaning that further game actions should be performed such as the unlocking of different game objects 8 or abilities unavailable with just one type of game accessory. Performing such functions with wireless links between the game accessories 7 and either the game controllers 2 or the game console 3 would be difficult because the wireless links would have to have the range to encompass the normal places on the two players would have the game controllers 2 and the game accessories 7 whilst not having such range as to register contact every time one player came unintentionally too close to the other.

FIG. 6 represents a computer program 3GP on which the game 3G may be based. A controlling module (CON) 61 communicates with, schedules (i.e. starts and stops execution of) and generally provides an environment (memory space and system resources) to an input module (INP) 62, a motion module (MOT) 63, a display module (DIS) 64 and an game object module 65. The input module receives commands from the game controller 2 via the communication link 4. These commands may contain, amongst other things, information concerning a game accessory 7 and positional information thereof. The motion module 63 calculates how game objects, including characters move in the game 3G as a result of commands from the player 1. The display module 64 transforms the results of the motion module and other information from other modules into a form suitable for the display 5. It may also have the job of sending the information for display via the communication link 6. The game object module 65 has the job of administering the objects used in the game—for example maintaining the identifiers and descriptions of the objects. The game object module 65 may also hold the information on game accessories 7, either in use or for potential use.

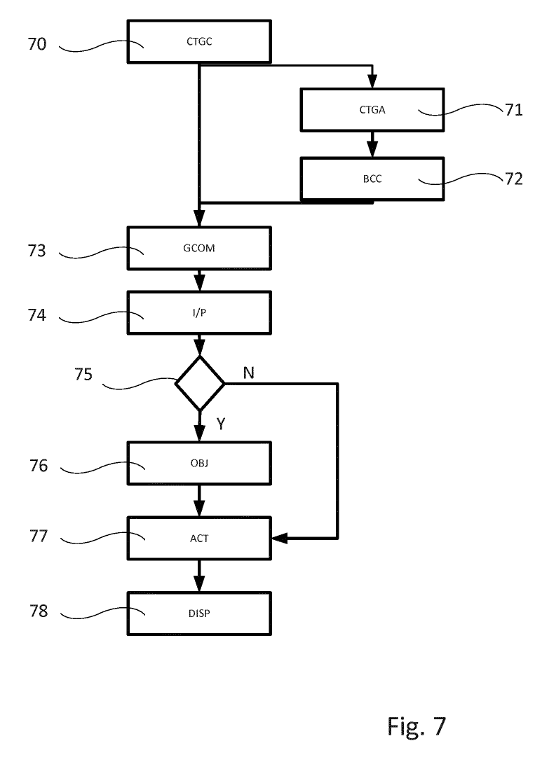

FIG. 7 represents a flow for playing a game including the registering of a game accessory 7 in a game 3G. At the start of play at step 70 (CTGC), the player 1 makes contact with the game controller 2. The flow passes to step 73 (GCOM) where the game controller 2 sends commands to the game 3G. Then or later at some point during game play, at step 71, the player touches, or otherwise comes into contact with, a game accessory 7 (CTGA). At step 72 (BCC), a body-coupled communication link is established between game controller 2 and game accessory 7 and information about the game accessory is passed to the game controller 2. The game controller 7 may also obtain positional information about the game accessory 7. The flow then rejoins the main flow at step 73, where like before, the game controller 2 sends games commands but which now contain information concerning the game accessory 7. At step 74, (I/P), these commands are received as input by the game 3G. At step 76, the game 3G decides if it needs to implement a particular game object 8. If the result is yes, step 76 (OBJ) in performed where the object is created in the game, otherwise the flow passes the next step, step 77 (ACT) where the game executes a game action which may involve the activation of the game object 8 which the presence of the game accessory 7 has permitted. At step 78 (DISP), the results of the game action are formulated for display and displayed. The advantage of this flow is the automatic and seamless implementation or activation of game objects 8 in the game without the player 1 having to change the way they interact with the game.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer or processing unit. In the device claim enumerating several means, several of these means may be embodied by one and the same item of hardware. The mere fact that certain measures are recited in mutually different dependent claims does not indicate that a combination of these measures cannot be used to advantage.

Aspects of the invention may be implemented in a computer program product, which may be a collection of computer program instructions stored on a computer readable storage device which may be executed by a computer. The instructions of the present invention may be in any interpretable or executable code mechanism, including but not limited to scripts, interpretable programs, dynamic link libraries (DLLs) or Java classes. The instructions can be provided as complete executable programs, partial executable programs, as modifications to existing programs (e.g. updates) or extensions for existing programs (e.g. plugins). Moreover, parts of the processing of the present invention may be distributed over multiple computers or processors.

Storage media suitable for storing computer program instructions include all forms of nonvolatile memory, including but not limited to EPROM, EEPROM and flash memory devices, magnetic disks such as the internal and external hard disk drives, removable disks and CD-ROM disks. The computer program product may be distributed on such a storage medium, or may be offered for download through HTTP, FTP, email or through a server connected to a network such as the Internet.

1. An activity controller comprising:
a body-coupled communication device configured to communicate, using body-coupled communications, the body coupled communications having an associated field, with an activity accessory device when both the body-coupled communication device and the activity accessory device are touched by an activity performer and to obtain, via the body-coupled communications, an activity accessory information; and a positional information indicative of the position, in terms of the activity performer's body, of the activity accessory device relative to the activity controller, wherein the accessory information comprises an identifier of an activity object and the positional information is at least in part based a measured value representing the strength of the associated field;
a processor configured to formulate activity commands for an activity console based on said activity accessory information and on said positional information, wherein said commands are configured to cause a computer program product, when run on the activity console, to implement the activity object in a computer program representation; and
a linking device configured to communicate said activity commands to the activity console.

2. The activity controller as claimed in claim 1, wherein the positional information is indicative of at least one of whether the activity accessory device is in direct contact or indirect contact with the activity-performer, a distance over the body surface between activity controller and the activity accessory, whether the activity controller and the activity accessory device are on the same limb or different limbs, and the area of skin contact between the activity performer and the activity accessory.

3. The activity controller as claimed in claim 1, wherein the measured value is obtained by a measurement performed by said body-coupled communications device.

4. An activity accessory device comprising a body-coupled communication device and configured to communicate, with an activity controller as claimed in claim 1, information arranged to cause the controller to produce a command for a console, the command causing a computer program product, when run on the activity console, to implement the activity object in a computer program representation.

5. The activity accessory device as claimed in claim 4 configured to store at least one of an activity performer's identity, the activities in which the activity accessory has been used, the performance in the activity of the activity performer and information to be used by the activity to implement the activity object.

6. The activity accessory device as claimed in claim 4, arranged to detect if it is in a holder as a status and communicate said status to the activity controller.

7. The activity accessory as claimed in claim 4, wherein the body-coupled communication device has two sets of coupling plates arranged to detect whether one or two hands are in contact with the activity accessory.

8. A computer software product stored on a no-transitory computer-readable medium, when run on an activity console having an activity object module configured to perform an activity action according to information concerning an activity accessory received from an activity controller, said activity accessory information being obtained by the activity controller using body-coupled communications with an activity accessory device.

9. The computer software product as claimed in claim 8, wherein the activity object module is configured to produce said activity object, the activity object being sensorially detectable by an activity performer.

10. The computer software product as claimed in claim 9, wherein the activity object module is configured to receive and process information to produce the activity object, the information being stored in the activity accessory device and received via the activity controller.

11. The computer program product as claimed in claim 8, further configured to perform activity actions based on positional information received from the activity controller, said positional information being representative of a distance over the surface of an activity performer's body between the activity controller and the activity accessory.

12. The computer software product as claimed in claim 11, wherein the executing of an activity action is further based on the positional information taken in conjunction with properties of an activity object associated with the activity accessory device.

13. A method of executing an activity action within a computer program product when run on an activity console comprising:
performing a measurement of a strength of a field associated with a body-coupled communication link to obtain a value;
receiving an information via a activity controller, the information being obtained by the activity controller using said body-coupled communication link with a activity accessory device when a activity performer's body is in contact with both the activity controller and the activity accessory device, wherein at least part of the information identifies the activity accessory device and at least part of the information provides an indication of a position, the indication being based on the value, of the activity accessory device, in terms of the activity performer's body, relative to the activity controller;
decoding said information and selecting an activity action in accordance with said information; and
sending commands to an activity console to cause the computer program product to implement the activity object in the activity within a representation produced by the computer program product.

14. The method as claimed in claim 13, wherein the activity action comprises producing sensorially detectable representation of an activity object.

15. The method as claimed in claim 13, wherein the information to produce the representation is stored in the activity accessory device and received via the activity controller.

16. The method as claimed in claim 13, further configured to perform an activity action based on the positional information received from the activity controller, said positional information being representative of a distance over the surface of an activity performer's body between the activity controller and the activity accessory.
